(19) United States
(12) Patent Application Publication
(10) Pub. No.: US 2024/0162998 A1
(43) Pub. Date: May 16, 2024

(54) METHOD OF CLOCK SYNCHRONIZATION FOR A DISTRIBUTED NETWORK

(71) Applicant: Systems & Technology Research, LLC, Woburn, MA (US)

(72) Inventors: James Vogel, Lynnfield, MA (US); Evan D. Walsh, Billerica, MA (US)

(21) Appl. No.: 17/572,936

(22) Filed: Jan. 11, 2022

Related U.S. Application Data
(60) Provisional application No. 63/135,894, filed on Jan. 11, 2021.

(51) Int. Cl. H04J 3/06

(52) U.S. Cl. CPC H04J 3/0638

(57) ABSTRACT

A method of clock synchronization for a distributed, message-passing network includes the step of dissecting a graphical model of the distributed network into a sequence of time-varying directed sub-graphs, each sub-graph including a selection of closed loops. By comparing the sequence of sub-graphs, the influence of each closed loop is quantified. Using the loop influence information, a selection of edges in the graphical model is dynamically identified for deletion using a hierarchically semiseparable structure in order to yield an optimized graphical model. A sum-product message-passing algorithm is then applied to the optimized graphical model to calculate a clock synchronization solution. By maintaining an optimal subset of closed loops within the model, the algorithm converges to a synchronization solution, while, at the same time, limits susceptibility to faults as well as maintains a sufficient degree of algorithmic complexity that streamlines the number of steps required to achieve convergence.

### CROSS-REFERENCE TO RELATED APPLICATIONS

The present application claims the benefit under 35 U.S.C. 119(e) to U.S. Provisional Patent Application No. 63/135,894, which was filed on Jan. 11, 2021 in the names of James Vogel et al., the disclosure of which is incorporated herein by reference.

### FEDERALLY SPONSORED RESEARCH OR DEVELOPMENT

This invention was made with government support under contract number FA9453-19-P-0529 awarded by Air Force Research Laboratory (AFRL). The government has certain rights in the invention.

### FIELD OF THE INVENTION

The present invention relates generally to the field of electronic communications and, more particularly, to time synchronization protocols applied to the individual nodes of a distributed sensor or communications network.

### BACKGROUND OF THE INVENTION

In a sensor or communications network, a plurality of individual compute devices is digitally interconnected to allow for the exchange of data, resources, and the like. A communication protocol is applied to the network to regulate the transmission of electronic data amongst the various compute devices, which are commonly referenced simply as nodes.

In a distributed network, the transmission of data is operationally dependent upon time synchronization amongst the individual nodes. For instance, a command which is designed to modify system code may utilize timing information to ensure that the most current version of the code is corrected. However, without proper clock synchronization, these types of code modifications may yield imperfect results.

Even when initially synchronized, the internal clock for each of the various independent nodes often counts time, or oscillates, at a slightly varying rate. As a result of this clock drift, nodes may observe certain events at different time intervals. Accordingly, individual clocks within a distributed network require periodic synchronization in order to ensure successful communications between nodes.

The communication protocol for a decentralized distributed network typically relies upon message passing amongst a selection of nodes in order to synchronize time. In other words, by routinely comparing the timing information for a selection of nodes in the network, a time inference algorithm can be implemented to in order to determine the proper time and, in turn, adjust the internal clock for each node accordingly.

Belief propagation is one type of message-passing algorithm applied to distributed networks for clock synchronization purposes. Belief propagation is a sum-product message-passing algorithm which performs probabilistic interference on a graphical model in order to calculate the marginal distribution for unobserved nodes using known values derived from observed nodes. A well-known mathematical formulation of belief propagation is represented as:

$${m}_{\{ ij \} ( {x}_{j} )} ← α {\sum }_{\{ {x}_{i} \}} {ψ}_{\{ ij \}} ( {x}_{i} , {x}_{j} ) {ψ}_{i} ( {x}_{i} ) {\prod }_{\{ k ∈ N ( i ) \backslash j \}} {m}_{\{ ki \}} ( {x}_{i} ) , \\ {b}_{i} ( {x}_{i} ) ← α {ψ}_{i} ( {x}_{i} ) {\prod }_{\{ k ∈ N ( i ) \}} {m}_{\{ ki \}} ( {x}_{i} ) , \\ P ( {x}_{1} , {x}_{2} , … , {x}_{N} ) = \frac{1}{Z} {\prod }_{ij} {ψ}_{\{ ij \}} ( {x}_{i} , {x}_{j} ) {\prod }_{i} {ψ}_{i} ( {x}_{i} ) , \qquad [ 1 ]$$

In equation [1], for an N-dimensional system, {m_{{i,j}}} represents a set of messages, {b_{{i,j}}} represents the associated beliefs calculated from those messages, ψ_{{i,j}}(xᵢ,xⱼ) is the compatibility matrix between nodes i and j, N(i)/j represents all nodes neighboring node i except node j, and α is a normalization constant. Ideally, the algorithm converges to a fixed point of the marginal density functions (i.e., a convergence solution), thereby enabling all clocks to be effectively synchronized.

However, certain aspects of the distributed network (e.g., the degree of initial clock variance) as well as how it is represented graphically can significantly impact synchronization results. For instance, in FIG. 1, a simplified example of a distributed network is shown, the network being represented generally by reference numeral 11. For ease of illustration and understanding, network 11 is described herein as a Global Positioning System (GPS) constellation comprised of a plurality of satellites, or nodes, 13-1 thru 13-6.

In FIG. 2, GPS constellation 11 is represented graphically as model 31, which incorporates edges 5 between pairs of nodes 13 that are in direct communication with one another. As can be appreciated, it has been found that the application of belief propagation algorithms to graphical models of the type shown in FIG. 2 does not always converge to a single solution.

Specifically, within graphical model 31, a cluster of nodes 13 may form a closed loop, or cycle, 17. Because a closed loop creates multiple communication paths between a single pair of nodes, the cluster may become overweighted in probabilistic calculations and, if unmitigated, can result in its synchronization information biasing global convergence properties and/or a node essentially synchronizing against itself. As a result, implementation of the synchronization algorithm often yields constant fluctuation in values and/or convergence to a spurious solution.

For this reason, node clusters within a probabilistic graphical model are often eliminated to reduce significance and impact. In the absence of loops in a graphical model, belief propagation algorithms are guaranteed to converge to a solution. For instance, in FIG. 3, GPS constellation 11 is represented graphically as model 51. As can be seen, graphical model 51 adopts a spanning tree approach, with all loops removed therefrom. In other words, communication between pairs of nodes 13 is restricted to a single connective path, or edge, 15.

Although guaranteed to converge to a solution, applying synchronization algorithms to loop-free graphical models (e.g., model 51) have been found to suffer from a couple notable shortcomings.

As a first shortcoming, synchronization algorithms applied to loop-free graphical models are sub-optimal with respect to algebraic connectivity. Due to its minimal algebraic connectivity, applying synchronization algorithms to loop-free modeling techniques necessitates a significantly greater number of mathematical steps to achieve convergence, particularly for larger sized constellations as well as greater initial timing variances between clocks. This significant increase in the number of mathematical steps required to achieve convergence necessitates a corresponding increase in the time required to complete computation, which is highly undesirable.

As a second shortcoming, synchronization algorithms applied to loop-free modeling techniques are rendered susceptible to dropout faults and Byzantine faults when any message-passing failure occurs between nodes. Because node failure is common in most synchronization applications, the faults must therefore be treated to ensure adequate results.

### SUMMARY OF THE INVENTION

In view thereof, it is an object of the present invention to provide a novel method of clock synchronization for a distributed network.

It is another object of the present invention to provide a method of clock synchronization of the type as described above that consistently converges to a synchronization solution.

It is yet another object of the present invention to provide a method of clock synchronization of the type as described above that is of sufficient algorithmic complexity.

It is still another object of the present invention to provide a method of clock synchronization of the type as described above that is sufficient resilient to faults caused by message-passing failures.

It is yet still another object of the present invention to provide a method of clock synchronization of the type as described above that is relatively secure and reliable.

It is another object of the present invention to provide a method of clock synchronization of the type as described above which is easy to configure and inexpensive to implement.

Accordingly, as one feature of the present invention, there is provided a method of clock synchronization for a distributed network, the method comprising the steps of (a) representing the distributed network as a graphical model, the graphical model comprising a set of nodes, wherein selected pairs of nodes in direct electronic communication with one another are shown connected by edges, (b) dissecting the graphical model into a sequence of time-varying directed sub-graphs, each sub-graph connecting the selected pairs of nodes in direct electronic communication with one another using directed edges, wherein each sub-graph includes a selection of closed loops between the plurality of nodes, (c) determining the influence of each closed loop within each sub-graph, (d) dynamically identifying a selection of edges for deletion in the graphical model based on the influence of each closed loop within each sub-graph, the deletion of edges from the graphical model yielding an optimized graphical model, and (e) applying a synchronization algorithm to the optimized graphical model to calculate a clock synchronization solution.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified schematic representation of an example of a Global Positioning System (GPS) constellation;

FIG. 2 is a prior art graphical model of the GPS constellation shown in FIG. 1, the model being designed for implementation of a time synchronization algorithm, the model including multiple closed loops;

FIG. 3 is a prior art graphical model of the GPS constellation shown in FIG. 1, the model being designed for implementation of a time synchronization algorithm, the model being in the absence of any closed loops;

FIG. 4 is simplified flow chart of a novel method of clock synchronization for a distributed network, the method being implemented in accordance with the teachings of the present invention;

FIGS. 5(a) and 5(b) represent an illustrative sequence of graphical models for a GPS constellation that are useful in understanding the graph dissection step for the clock synchronization method shown in FIG. 4;

FIG. 6 is an illustrative graphical model for a GPS constellation that is useful in understanding the edge deletion algorithmic step for the clock synchronization method shown in FIG. 4;

FIG. 7 is a graph of actual test results achieved by the clock synchronization method of FIG. 4 compared against prior art clock synchronization algorithms which use either standard loop-inclusive or spanning tree techniques, the graph being represented in terms of steps to convergence in relation to initial time variance between node clocks;

FIG. 8 is a graph of actual test results achieved by the clock synchronization method of FIG. 4 compared against a prior art clock synchronization algorithm which uses a spanning tree technique as well as the theoretical lower bound graph for the test, the graph being represented in terms of steps to convergence in relation to constellation size; and

FIG. 9 is a graph of actual test results achieved by the clock synchronization method of FIG. 4 which illustrates the resiliency of the time synchronization method of the present invention to node faults, the graph being represented in terms of steps to convergence in relation to the number of faulty nodes within the test constellation.

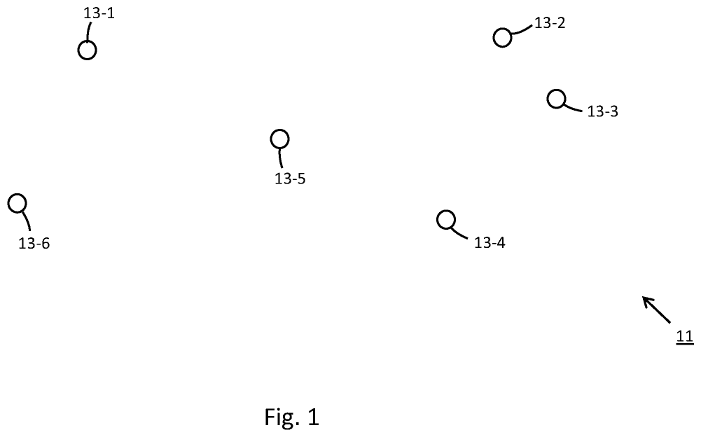

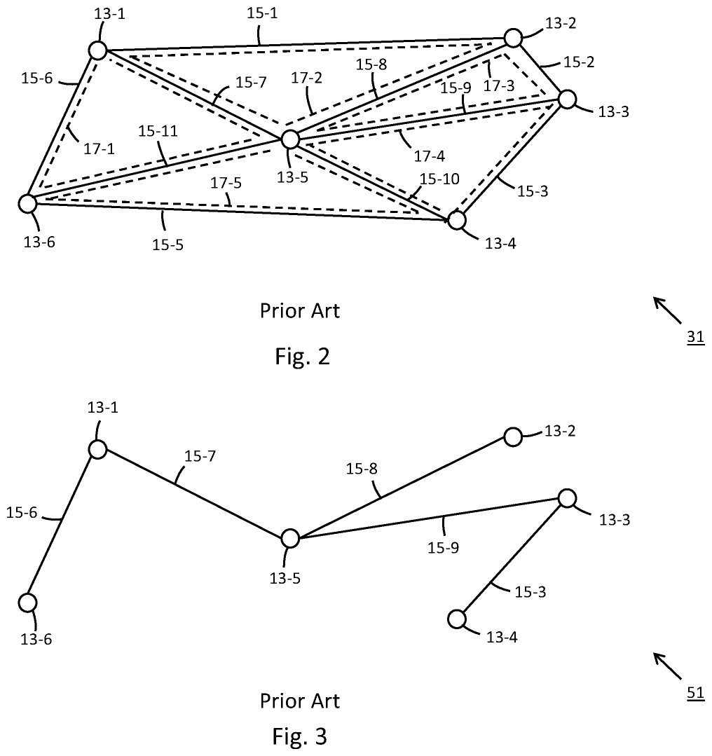

### DETAILED DESCRIPTION OF THE INVENTION

### Clock Synchronization Method 111

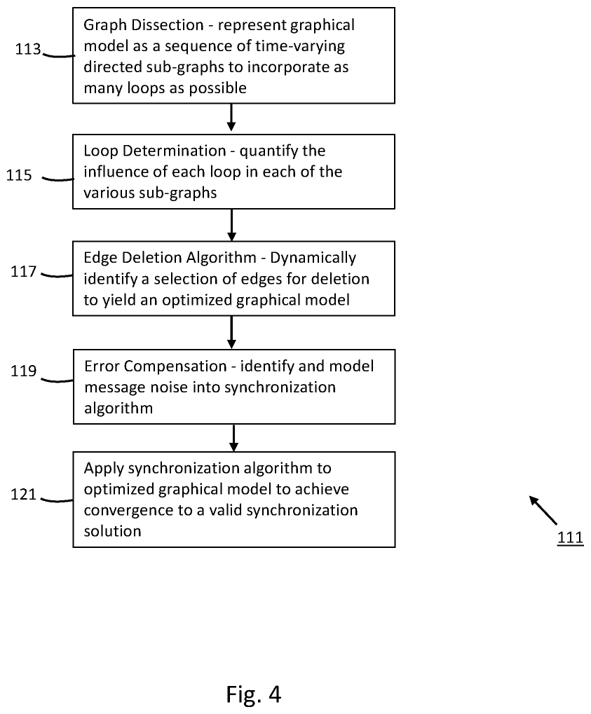

Referring now to FIG. 4, there is shown a flow chart which represents a novel method of clock synchronization for a distributed, message-passing network, the method being implemented according to the teachings of the present invention and identified generally by reference numeral 111. As will be explained in detail below, clock synchronization method 111 applies a novel time synchronization technique which evaluates the influence of closed loops within synchronization models and, in turn, dynamically maintains an optimized selection of the closed loops within the model during implementation of the synchronization algorithm. By maintaining an optimal subset of the closed loops within the model, method 111 is designed to ensure convergence to a synchronization solution, while, at the same time, limit susceptibility to faults as well as maintain a sufficient degree of algorithmic complexity in order to streamline the number of steps required to achieve convergence to the synchronization solution.

For ease of understanding, method 111 is described in relation to GPS constellation 11. However, it is to be understood that the method of present invention is not limited to inter-satellite communications. Rather, it is to be understood that method 111 could be similarly implemented in other forms of distributed message-passing systems (e.g., radar systems, underwater systems, and the like) without departing from the spirit of the present invention.

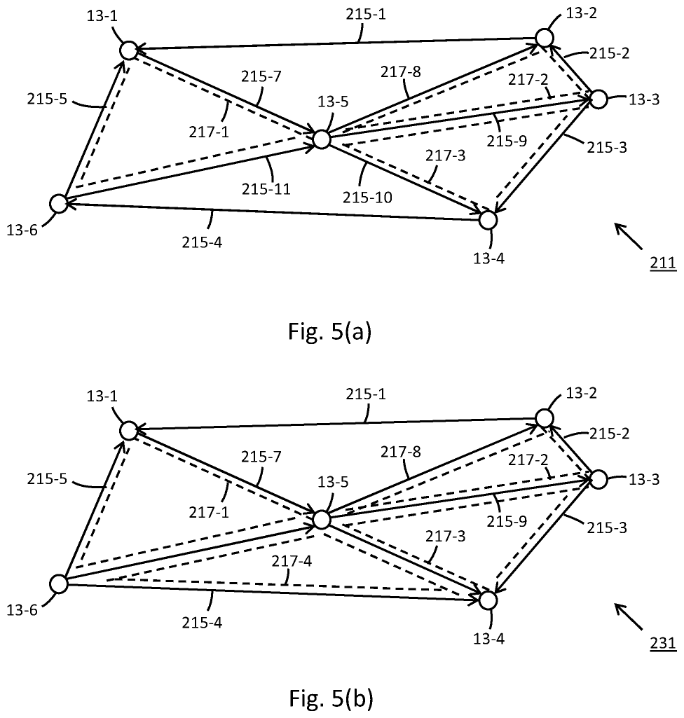

As can be seen, method 111 commences with a graph dissection step 113 in which the graphical model for the distributed network in need of clock synchronization is represented as a sequence of time-varying directed sub-graphs. Referring now to FIGS. 5(a) and 5(b), a sequence of graphical models for GPS constellation 11 is shown which help illustrate graph dissection step 113.

Specifically, in FIG. 5(a), an illustrative time-varying directed sub-graph 211 of GPS constellation 11 is shown. As can be seen, in sub-graph 211, directed edges 215 connect nodes 13 in GPS constellation 11. Because edges 215 have a specified direction, a limited number of closed loops 217 are formed, with each closed loop 217 representing the presence of multiple communication paths between a pair of nodes 13. In the present example, three closed loops 217-1, 217-2, and 217-3 are identified.

In FIG. 5(b), an illustrative time-varying directed sub-graph 231 of GPS constellation 11 is shown. As can be seen, sub-graph 231 differs from sub-graph 211 solely in the direction of edge 215-4. However, it should be noted that the change of direction for edge 215-4 yields a fourth closed loop 217-4 within sub-graph 231. As will be explained further below, the ability to quantitatively compare differences between the individual sub-graphs (e.g., sub-graph 211 against sub-graph 231) enables the effects of each loop to be measured.

Referring back to FIG. 4, in step 115, the influence of each loop within each of the various sub-graphs for GPS constellation 11 is explicitly quantified. By quantifying the effects of each loop, an optimized selection of loops can be dynamically maintained in the representative model for the designated network. In other words, heavily biased, or overweighted, local loops can be mitigated, while benign loops can be maintained. In this manner, the quantitative effects of useful loops are exploited by method 111 to ensure convergence to a synchronization solution, while limiting susceptibility to faults and minimizing the number of steps required to achieve convergence.

Using the loop quantification results, an edge deletion algorithm is applied in step 117 to identify a selection of edges for deletion within the graphical model for the designated network. Edge deletion step 117 is preferably implemented using the paradigm of hierarchical semiseparable (HSS) matrices as the relaxation in the optimal edge deletion algorithm. Similar to a standard binary tree structure, the preferred edge deletion algorithm prescribes ranges of ranks for various blocks within the corresponding HSS tree. However, the prescribed ranges of ranks are determined dynamically using randomized methods rather than from pre-computations, as HSS formalism is well suited to perform these types of computations.

Based on known attributes of HSS matrix algorithms, edge deletion step 117 has near-linear complexity with respect to the electronic messages passed in order to achieve solution convergence. Notably, using a small constant, k, which is equal to the maximum chromatic number of the adjacency graph for a constellation, the complexity of the number of time transfers for a given node of an HSS tree can be represented as:

$${γ}_{i} = {\sum }_{r = i}^{{log}_{2} n} {2}^{r - l} \cdot k \cdot O ( \frac{n}{{2}^{r}} ) = O ( r \cdot n / {2}^{r} ( {log}_{2} n - r ) ) \qquad [ 2 ]$$

By combining all nodes for an HSS tree, the following expression is reached, if suitable assumptions are made on the error distributions of the messages and non-pathological local geometries:

$$γ = {\sum }_{l = 1}^{{log}_{2} n} {2}^{l} {\sum }_{r = l}^{{log}_{2} n} {2}^{r - l} \cdot k \cdot O ( \frac{n}{{2}^{r}} ) = O ( n log n ) \qquad [ 3 ]$$

Accordingly, it is to be understood that the number of messages required to be passed by a network using method 111 in order to achieve synchronization is in the order of O(n log n), where n the is the number of nodes in the graph.

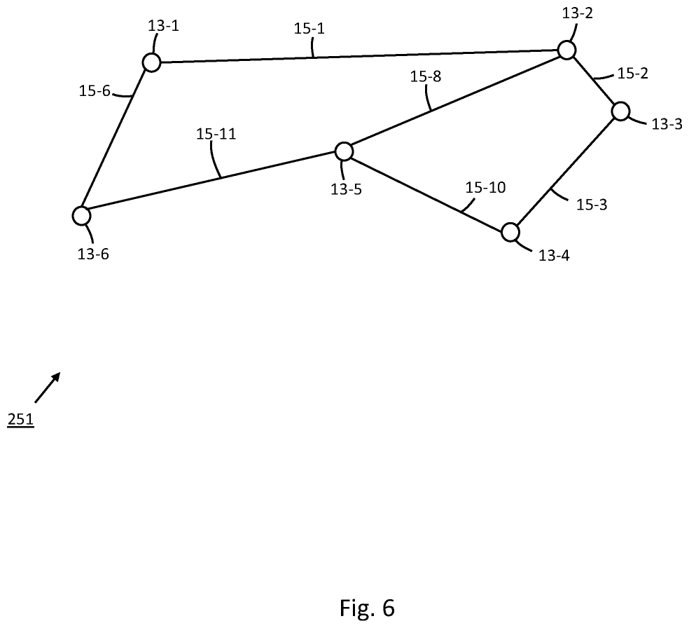

Upon completion of edge deletion step 117, an optimized graphical model for the intended distributed network is defined. For example, in FIG. 6, an optimized graphical model 251 for GPS constellation 11 is shown. As can be seen, an optimized selection of edges 15 remain between nodes 13 that ensure convergence to a synchronization solution with near-optimal algorithmic complexity.

Referring back to FIG. 4, an optional error compensation step 119 may be incorporated into method 111 in order to ensure optimal synchronization convergence. For instance, message noise can be accurately modeled with a distribution function and therefore treated as part of compensation step 119.

Finally, in step 121, a clock synchronization algorithm is applied to the optimized graphical model to achieve convergence to a valid synchronization solution. By optimizing the graphical model for the intended network (i.e., by including an optimal set of closed loops), a standard belief propagation algorithm can be applied to the graph to yield the synchronization solution.

### Illustrative Algorithms for Implementing Synchronization Method 111

It should be noted that various algorithms could be designed to implement clock synchronization method 111. For illustrative purposes only, sample synchronization algorithms are provided herein. However, it is to be understood that the algorithms shown below are provided for illustrative purposes only and are not intended to limit the scope of the present invention.

For any distributed synchronization application in which the connectivity of the distributed network has a known and periodic formulation (e.g., a GPS satellite constellation), the below algorithm would be particularly well suited to yield a valid synchronization solution:
Input: Message data
   Message data error distribution
   Periodic connectivity information
   (optimal) Positional data of physical nodes
   (optional) Tolerance for synchronization
Output: Vector of synchronized data
(1) Precompute relaxation parameters based on periodicity properties
(2) while Convergence Condition A is not satisfied
(3) Select node with highest connectivity; denote Node 1
(4) Re-order nodes based on their distance to Node 1
(5) Perform nested dissoction on adjacency graph
(6) Generate list of allowable deletions from (1); let n=cardinality of this list
(7) for i=1:n
(8) Calculate spectral metrics for candidate function
(9) end
(10) Select candidate which minimizes spectral function
(11) and
(12) Perform standard belief propagation on augmented graph
Here Convergence Condition A is as follows:

$${( {f}^{′} ( v ) )}_{i \to j , k \to l} = \frac{\partial {v}_{i \to j}^{′}}{\partial {v}_{k \to l}} = {A}_{i \to j , k \to l} {B}_{i \to j} ( v ) < 1 , where \\ {B}_{i \to j} ( v ) = ( 1 - {tanh}^{2} ( {θ}_{i} + \sum t ∈ ij {v}_{t} \to i ) / ( 1 - {tanh}^{2} ( {v}_{i \to j}^{′} ( v ) ) ) \\ {A}_{i \to j , k \to l} = tanh \vert {J}_{ij} \vert {δ}_{i 1} {1}_{\partial ij} ( k )$$

where:
   vᵢ₋ⱼ is a message seat from node i to node j
   A is a quasi-linear mapping from the space of messages onto itself
   B is the adjacency matrix for the system at time t
   Jᵢⱼ is the Jacobian with respect to edge removal
   Bᵢ are the associated error parameters of the system

In certain applications, it is often desirable or necessary to select a subset of nodes within a graph to actively broadcast messages, with the remaining nodes designated to only receive messages. Restricting electronic message transmission to a subset of nodes is often preferred for, among other things, energy constrains, security concerns, and interpretability considerations. The following algorithm is uniquely designed to resolve this particular issue:
Input: Periodic connectivity information.
Output: List of nodes in subset
(1) Form graph G
(2) for i=1:7
(3) for j=1:(31−i)
(4) Form graph G{i}/j and calculate the smallest Laplacian eigenvalue
(5) end
(6) Delete node j the maximized and form G{(i+1}=G{i}/j
(7) end

For any distributed synchronization application in which the connectivity of the distributed network has either (i) a known and periodic formulation or (ii) no known periodic formulation, the two aforementioned algorithms can be used as subroutines within the algorithm provided below to yield a valid synchronization solution:
Message data
   Message data error distribution
   (optimal) Positional data of physical nodes
   (optional) Tolerance for synchronization
Output: Vector of synchronized data
(1) From the Laplacian matrix A for the satellite network
(2) Transform A to banded form using nested dissection
(3) for nodes (separators) i=1,2, . . . root(T)−1
(4) Select transmitting satellites using generalization of Algorithm 2
(5) if i is a leaf
(6) Compute free energy of network represented by submatrix
(7) else
(8) Compute rank revealing QR decomposition of submatrix
(9) end
(10) end
(11) for nodes (separators ) i=root(T)−1, root(T)−2, . . . , 1
(12) if par(i)=root(T)
(13) Partition orthogonal basis into a direct sum of trees
(14) Message update sub-routine
(15) Message normalization sub-routine
(16) else
(17) Re-compress larger submatrix
(18) end
(19) Perform Algorithm 1 on subgraph
(20) end

### Actual Test Results Achieved Using Synchronization Method 111

As referenced above, clock synchronization method 111 ensures convergence to a synchronization solution, while limiting susceptibility to node faults and maintaining a near-optimal degree of mathematical complexity. For comparative purposes, method 111 was tested in relation to conventional clock synchronization algorithms which use either standard loop-inclusive or spanning tree techniques. The results of the aforementioned testing are detailed below. The following results are provided for illustrative purposes only and are not intended to limit the scope of the present invention.

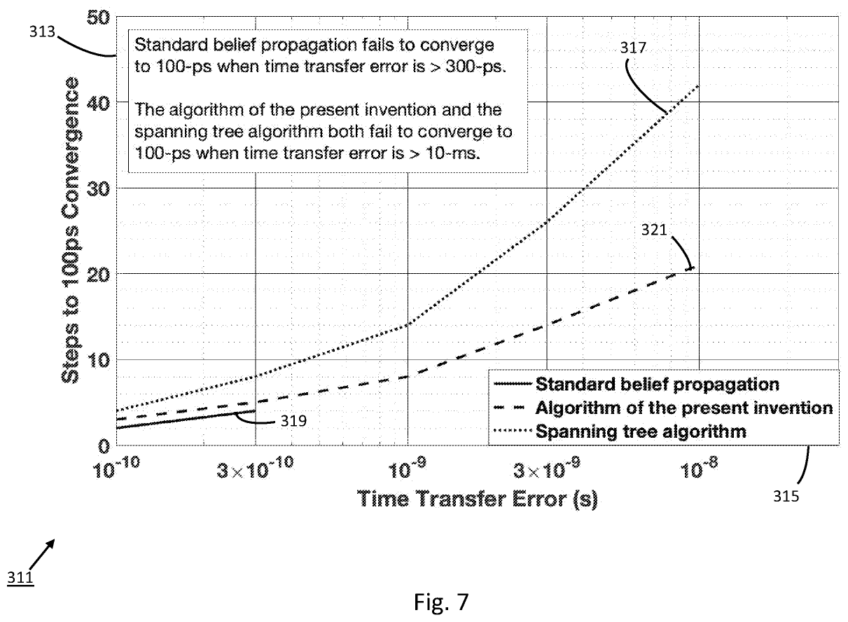

Specifically, in FIG. 7, a graph is shown which illustrates various clock synchronization techniques applied to a set of test parameters, the comparative graph being identified generally by reference numeral 311. In graph 311, the results of each synchronization technique are represented along vertical axis 313 in terms of steps to convergence and along horizontal axis 315 in terms of initial variance between node clocks (i.e., time transfer error).

As can be seen, a standard spanning tree algorithm 317 reaches convergence to within 100 ps in a reliable fashion, but often requires a considerable number of steps (i.e., processing time). Furthermore, it can be seen that a conventional loop-inclusive, belief propagation algorithm 319 is unable to achieve convergence for test networks with time variance greater than 300 ps.

By comparison, an algorithm 321 designed to implement synchronization method 111 is able to achieve convergence within the same range of time transfer errors as spanning tree algorithm 317 but at approximately half the number of steps. In other words, method 111 produces the same degree of convergence reliability as synchronization protocols which adopt a spanning tree approach but at a considerably faster rate of convergence.

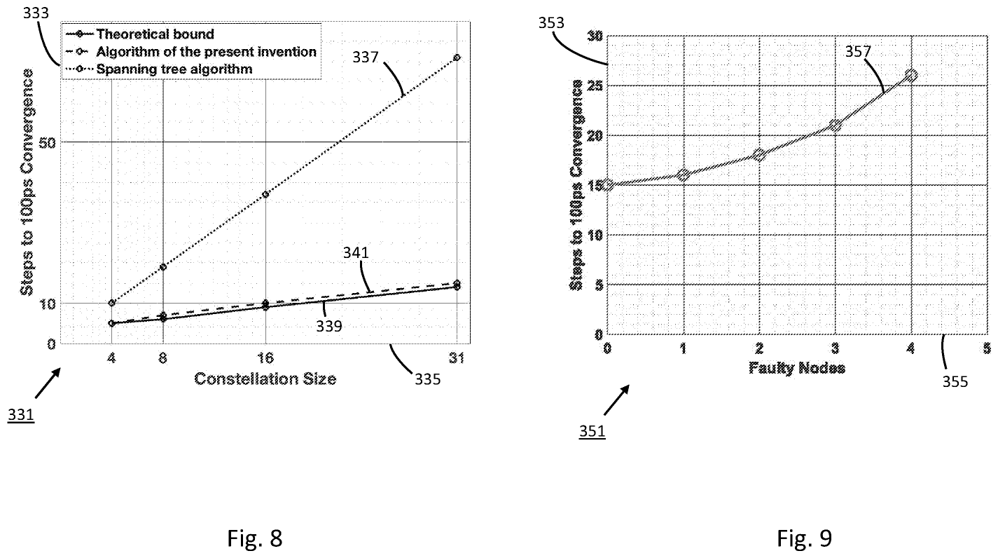

In FIG. 8, another graph is shown which illustrates various clock synchronization techniques applied to a set of test parameters, the comparative graph being identified generally by reference numeral 331. In graph 311, the results of each synchronization technique are represented along vertical axis 333 in terms of steps to convergence and along horizontal axis 335 in terms of constellation size (i.e., number of nodes in the test network).

As can be seen, a standard spanning tree algorithm 337 reaches convergence to within 100 ps in a reliable fashion but requires a significantly greater number of convergence steps as the constellation size increases. A theoretical lower bound graph 339 is provided to help illustrate the relative ineffectiveness of spanning tree algorithm 337 with networks which are moderately large in size.

By comparison, an algorithm 341 designed to implement synchronization method 111 is able to achieve convergence at the same approximate rate as theoretical lower bound graph 339 across all constellation sizes. As a result, method 111 can be regarded as being highly scalable.

In FIG. 9, a graph 351 is shown which illustrates the fault tolerance of method 111, graph 351 being represented along vertical axis 353 in terms of steps to convergence and along horizontal axis 355 in terms of the number of faulty nodes in the test network. As can be seen, an algorithm 357 designed to implement synchronization method 111 is able to achieve convergence even with a limited number of faulty nodes. However, as the number of faulty nodes increases, a commensurate number of additional steps is required in order to achieve solution convergence to 100 ps.

In view thereof, method 111 appears to be sufficiently resilient to faults. In fact, it has been determined that as long as at least two-thirds of the network nodes continuously provide uncorrupted data, the synchronization algorithm of the present invention will converge to a valid synchronization solution.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method of clock synchronization for a distributed network, the method comprising the steps of:
(a) representing the distributed network as a graphical model, the graphical model comprising a set of nodes, wherein selected pairs of nodes in direct electronic communication with one another are shown connected by edges;
(b) dissecting the graphical model into a sequence of time-varying directed sub-graphs, each sub-graph connecting the selected pairs of nodes in direct electronic communication with one another using directed edges, wherein each sub-graph includes a selection of closed loops between the plurality of nodes;
(c) determining the influence of each closed loop within each sub-graph;
(d) dynamically identifying a selection of edges for deletion in the graphical model based on the influence of each closed loop within each sub-graph, the deletion of edges from the graphical model yielding an optimized graphical model; and
(e) applying a synchronization algorithm to the optimized graphical model to calculate a clock synchronization solution.

2. The method as claimed in claim 1 wherein the synchronization algorithm utilized in the algorithm application step is a message-passing algorithm.

3. The method as claimed in claim 2 wherein the synchronization algorithm utilized in the algorithm application step is a sum-product message-passing algorithm.

4. The method as claimed in claim 2 further comprising the step of, prior to the algorithm application step, compensating for message-passing errors.

5. The method as claimed in claim 4 further comprising the step of, prior to the algorithm application step, compensating for message noise.

6. The method as claimed in claim 2 wherein, in the determining step, the influence of each closed loop within each sub-graph is quantified by comparing differences between multiple sub-graphs.

7. The method as claimed in claim 6 wherein, as part of the determining step, closed loops which are determined to be biased are mitigated.

8. The method as claimed in claim 7 wherein, as part of the determining step, closed loops which are determined to be benign are maintained.

9. The method as claimed in claim 2 wherein an edge deletion algorithm is applied in the edge identification step to identify a selection of edges for deletion in the graphical model.

10. The method as claimed in claim 2 wherein the edge deletion algorithm utilizes a hierarchically semiseparable (HSS) structure.
